(19) United States
(12) Patent Application Publication
(10) Pub. No.: US 2006/0150495 A1
(43) Pub. Date: Jul. 13, 2006

(54) Anaerobically digested fiber for use as a container media substrate

(76) Inventor: Craig Bruce MacConnell, Bellingham, WA (US)

Correspondence Address: LATIMER IP LAW, LLP, 13873 PARK CENTER ROAD, SUITE 122, HERNDON, VA, 20171, US

(21) Appl. No.: 11/316,840

(22) Filed: Dec. 27, 2005

Related U.S. Application Data
(60) Provisional application No. 60/639,855, filed on Dec. 27, 2004.

(51) Int. Cl. A01G 31/00

(52) U.S. Cl. 47/59 S

(57) ABSTRACT

The present invention provides a soilless media for growth of plants. The media comprises anaerobically digested fiber, which has had its pH adjusted by the addition of elemental sulfur. The pH-adjusted fiber has suitable physical properties, a suitable pH, and available manganese and iron for growth and maintenance of plants.

### CROSS-REFERENCE TO RELATED APPLICATIONS

The present application relies on and claims the benefit of the filing date of U.S. provisional patent application No. 60/639,855, filed on 27 Dec. 2004. Priority of the filing date of that application is claimed, and its disclosure is incorporated herein in its entirety by reference.

### BACKGROUND OF THE INVENTION

1. Field of the Invention

The present invention relates to soilless media for growth of plants. More specifically, the present invention relates to use of anaerobically digested manure, which has been treated with elemental sulfur, as a substrate for growth of plants, such as plants grown in containers in the nursery and greenhouse industries.

2. Description of Related Art

As environmental regulations become more stringent and energy prices rise, there is increasing interest world-wide in using anaerobic digestion (AD; also used as an abbreviation for “anaerobically digested” and “anaerobic digester”) technology for the treatment of manure from concentrated animal feeding operations. Although this technology is known to be effective in treating manure waste, and in producing useable energy through such treating, the technology has still not been widely adopted. The major limitation to wider adoption of this technology is its high capital cost. For example, a state of the art plug flow anaerobic digester for a 1,500 cow dairy farm in the Pacific Northwest area of the United States is estimated to cost $1.6 million to build. Furthermore, although there is a wealth of knowledge and numerous inventions relating to AD technology, the currently available technology still cannot offer a cost-effective solution for farmers, particularly those with farms that produce high solids content, such as dairy farms. T fact is evidenced by EPA surveys, such as those conducted under the AgStar program, which show that AD technology should be used in at least 6,500 large dairy farms, but is, in fact, used in fewer than 50 of such farms. This is a startling low number, which is attributed primarily to the high capital costs of installing AD technology on a farm, and the low price that can be obtained for the methane produced from the AD. Similar situation exist in many other countries throughout the world, and in particular, Europe. Although many digester units have recently been built, very few of these units are economically viable without governmental subsidies or inflated electricity prices. Technological advancement is required to make AD cost-effective.

AD technology produces two main products: gaseous methane and solid, digested manure. The methane (natural gas) can be collected and burned to produce electricity and heat. The electricity produced can be used to run the AD, and excess electricity sold to local power companies or directly to consumers in the area. The solid, anaerobically digested manure is a waste product that must be disposed of Typically, it is trucked to landfills for disposal or distributed on the surface of agricultural or open land as a harmless soil additive. In view of the cost of removal of the solid, digested manure, it is evident that alternative uses of the digested manure that would generate, rather than consume, money, would be beneficial. Indeed, depending on the amount of money that could be generated from this waste product, the cost of implementing and running AD technology could be significantly reduced, or even rendered profitable for the farmer.

In contrast to its use in the agriculture industry as a harmless amendment to soil, anaerobically digested manure has not seen use in the greenhouse or nursery industry, due to its poor qualities as a soil substitute. Greenhouses and nurseries, which typically cater to the residential and office markets, grow plants under controlled conditions in media that lacks soil (i.e., soilless media). These media are preferred to those containing soil because of their light weight, defined conditions, and beneficial growth properties. Typically, soilless media used in the greenhouse and nursery industries contain peat moss as a main ingredient.

Container-grown plants have become an important aspect of these industries, as containers provide a convenient way to grow, ship, and sell a variety of plants (e.g., trees, shrubs, flowers, vegetables). Indeed, growth of plants in containers has become the standard method in these industries for supplying and maintaining many, if not most plants. In view of the economic importance of container plants, much time and research has been expended to develop and optimize container growth conditions. Chief among the research goals has been to identify new substrates that are suitable for growth of a large number of different plants.

Peat moss, softwood bark, or a combination of the two is currently the primary base for most greenhouse and nursery container growth substrates. Peat moss in particular is an excellent substrate for container plant growth and maintenance. However, peat moss has some drawbacks. In particular, because it is a non-renewable natural resource, projections show that the cost for it will increase over the next few decades. Furthermore, environmental concerns about mining peat moss are projected to significantly limit its availability and use in the future.

Investigators have considered alternatives to peat moss as a substrate for container plants. For example, Tyler et al. investigated the use of animal waste as a soilless container medium substitute for peat moss. These investigators determined that composted turkey litter could be used as a plant growth substrate in combination with other substrates. However, they did not conclude that it was suitable as the sole substrate. In fact, the investigators found that the animal waste tested was unsuitable as the sole substrate for growth of container plants.

Thus, there is a continuing need in the art for improved substrates for container plants. In particular, there is a need in the art for a relatively inexpensive and abundant substrate that can be used as the sole substrate, or as the main constituent of a substrate, for growth and maintenance of container plants.

### SUMMARY OF THE INVENTION

The present invention provides a container media for growth of a variety of plants. In its basic form, the invention provides a substrate for growth of container plants in soilless media, which can be used alone or in combination with other substances. As used herein, a substrate is composition that contains all of the components of the root rhizosphere in a container. Thus, it is any material or combination of materials used to provide support, water retention, aeration, and/or nutrient retention for plant growth. Other terms that are used herein interchangeably with “substrate” are “medium” and “mix”.

The substrate comprises anaerobically digested manure, which is also referred to herein as “fiber”. According to the invention, the fiber is treated with elemental sulfur to acidify it. Among other things, acidifying the fiber with elemental sulfur not only provides sulfur for the plants, but releases nutrients from the fiber that would otherwise be unavailable to the plants to be grown in the containers. The substrate can contain the pH-adjusted fiber as the sole component of the substrate. Alternatively, the pH-adjusted fiber can make up the majority of the volume of the substrate, or can be the sole nutrient-containing component of the substrate. The pH-adjusted fiber can be provided in a highly consistent quality, as a result of close control of the anaerobic digestion process producing the fiber in conjunction with careful application of regulated amounts of elemental sulfur to the fiber. Furthermore, because the fiber that is used is a by-product or waste product of the farming industry, the present invention provides not only an economically advantageous way of producing a container medium, but reduces waste from the farming industry. In view of the substrate components, the present invention provides for use of elemental sulfur to produce a medium for growth of plants in a container.

In a second aspect, the present invention provides methods of making the substrate of the invention. In general, the methods of making the substrate comprise providing fiber, and reducing the pH of the fiber by addition of elemental sulfur. In preferred embodiments, the sulfur is mixed well with the fiber, and optionally, the pH is measured and adjusted to a pre-determined value or range.

In a third aspect, the invention provides methods of using the substrate of the invention to grow plants. In general, the methods of growing plants comprise providing the substrate and contacting the substrate with a plant (as used herein, this term is used to include a portion of a plant, such as a cutting, and a plant seed). Although the plant is typically contacted with the substrate in a container, contacting can occur in container-like settings within in-ground plots, such as those found in nursery and greenhouse settings. The methods of using the substrate to grow plants typically include maintaining the plant in contact with the substrate for a sufficient amount of time for the plant to grow at least a detectable amount. Accordingly, in embodiments, the invention provides for use of the substrate to grow plants.

### BRIEF DESCRIPTION OF THE DRAWINGS

The accompanying drawing, which is incorporated in and constitutes a part of this specification, illustrates data supporting embodiments of the invention, and together with the written description, serves to explain certain principles of the invention.

FIG. 1 depicts a graph of the drop in pH over time of pH-adjusted fiber.

### DETAILED DESCRIPTION OF VARIOUS EMBODIMENTS OF THE INVENTION

Reference will now be made in detail to various exemplary embodiments of the invention. The following detailed description is provided to explain in detail certain exemplary aspects and embodiments of the invention, and should not be considered as limiting the scope of the invention to the particular exemplary embodiments described.

Anaerobically digested fiber, such as that resulting from AD of dairy-derived manure, often possesses the appropriate physical properties to be used as a container media substrate (i.e., as a replacement for peat moss or hardwood or pine bark in a soilless medium). However, its use is severely limited due to its high pH, which makes essential plant nutrients, such as iron and magnesium, unavailable for plant absorption and use. The inventor has now surprisingly found that adding elemental sulfur, alone, at defined rates to anaerobically digested fiber, such as that from a dairy manure source, allows adequate availability of plant nutrients, such as iron and manganese. Making these nutrients available to the plants converts the fiber from a waste product of the anaerobic digestion process to a suitable component, and indeed an advantageous substrate, for container media. In particular, the pH-adjusted substrate is a suitable substitute for peat moss and/or composted bark as a substrate in soilless container media.

There are many incentives for dairy farms to export excess nutrients (in the form of manure byproducts) off of the farm due to environmental concerns and regulations. Anaerobic digestion is one method of treating dairy manure and other manure from farms. However, anaerobic digesters are capital intensive facilities that are typically repaid by way of sale of electricity from captured methane, which is then used by internal combustion engines to drive electrical generators, and by charging user fees to farmers who want their farm's manure digested. In many parts of the U.S. and the rest of the world, electric rates are sufficiently low to preclude building and running an AD economically (i.e., at a break-even cost). One way to improve the use of AD technology, and thus to reduce waste from farms, is to use solids from the digester (i.e., fiber) as a replacement for peat moss or composted bark in container media, particularly in the greenhouse and nursery industries. The present invention promotes such use by converting the essentially inert fiber produced from AD technology into a useful product for industry and home use.

At a basic level, the present invention is a process to further treat fiber that originates as agriculture manure (e.g., dairy cow manure) that has already been treated by way of AD. Further treatment according to the invention creates a substrate component of soilless media (e.g., potting soil) used for containerized plant production by the greenhouse, nursery (e.g., ornamental nurseries), and food plant (e.g., strawberries, peppers, tomatoes) industries. In order for a soilless media to be useful as a substrate component for container plants, is should possess specific properties, both physical and chemical. Fiber from AD has been found to have the appropriate physical properties for use as a container plant substrate. However, it has been found to lack the appropriate chemical properties to support germination, growth, and/or maintenance of plants in soilless media, when used as the sole organic component of the media. The present invention addresses this deficiency by modifying the anaerobically digested manure so that it has the correct chemical properties to grow containerized plants. In embodiments, it is superior to peat moss as a substrate for growth of container plants.

The greenhouse and nursery industries are under pressure from consumer groups, so-called environmentalist groups, and federal and state governments to find a suitable replacement for peat moss, as some people consider peat moss as a non-renewable, non-sustainable product. Some people also see the use of peat moss as a soilless media for plant growth as a practice that results in ecological damage because the peat moss originates from peat bogs, and must be removed prior to use in container media. In addition, most peat moss is imported into the U.S.; thus, its supply can be inconsistent, diminished, or lost due to political decisions outside of the control of U.S. media producers and consumers.

The present invention provides a means for converting a waste product of AD, which has marginal economic value, into an economically valuable product. The invention provides a process that chemically modifies anaerobically digested manure, particularly agricultural manure such as dairy manure. The process allows the end product to be used as a one-to-one substitute for peat moss as a container plant substrate. The substrate of the invention exceeds commonly recognized plant performance standards, such as fresh weight and “greenness” (as measured by, for example, a Minolta SPAD meter), which are the primary consumer demanded characteristics for a container substrate.

Typically, container media contains two main ingredients: peat moss and an inert substance that is included to increase porosity and reduce bulk density. The peat moss typically comprises about 60% to about 80% of the volume, while the inert substance comprises 20% to 40% of the volume. The inert ingredient is typically pumice or perlite, but can be other substances as well. In some soilless media, composted bark, either hardwood or softwood bark (e.g., pine bark), replaces some or all of the peat moss. Other, minor ingredients can be included, such as sand, clay, and fertilizers, but these typically make up a minority of the total volume of the container media. The pH-adjusted fiber of the present invention provides a substitute for peat moss and composted bark in soilless media.

One benefit of the acidification process of the present invention is to make available to the growing plants specific necessary plant nutrients, including, but not necessarily limited to, iron and manganese. The nutrients that are released by acidification by elemental sulfur according to the process of the invention are important nutrients that otherwise must be added to fiber to make the fiber suitable for use as a plant growth substrate. Without external addition of the missing nutrients, unacidified fiber, when used as the primary component of soilless media, is unmarketable due to its inability to support growth and maintenance of plants. However, when the process of the present invention is applied to AD produced fiber, bound nutrients are made available without the need to supply them from an external source, and plant growth is obtained. Thus, the present invention provides an effective substrate for growth of plants in soilless media without the need to add various nutrients from external sources.

In a first aspect, the present invention provides anaerobically digested manure that has been treated with elemental sulfur to reduce its pH. This product is referred to herein as pH-adjusted fiber. It can be used as a substrate for growth of plants. In particular, it is advantageously used as a substrate for growth of plants in soilless media, such as that used in container plants.

The anaerobically digested manure, or fiber, can be obtained from any of the known AD technologies. In particular, the fiber is the solid fraction of the effluent of AD. It can be separated from the liquid effluent by a screw press, an inclined screen, a gravity separator, or any other suitable process known in the industry for separating solids from liquids. The solid fiber produced from the AD technology, and separated from the liquid fraction, has been found to have the appropriate physical characteristics for growth of containerized plants. That is, it has an appropriate range of particle sizes to provide strength for the plant roots, sufficient spaces between particles for water and air migration, yet sufficiently small spaces between particles to promote adequate water and nutrient retention, and high cation exchange capacity (CEC), which measures the ability to hold, store, and release plant nutrients that are in the cation form (positive electrical charge). Unfortunately, the untreated fiber, as produced from the AD, does not have the appropriate chemical properties to support plant growth and maintenance. Thus, the invention provides the missing chemical properties by adjusting the pH of the fiber with elemental sulfur.

The source of the manure can be any source. Thus, it may be human waste or animal waste. However, as discussed above, the main concern at this time is treatment and disposal of animal wastes from intensive agricultural practices. Thus, it is envisioned that the present invention will be typically applied in the context of manure from animal husbandry. Thus, in embodiments, the manure is from one or more farm animals. Non-limiting examples of farm animals from which the manure is obtained are bovines (e.g., cattle and dairy cows), ovines (e.g, sheep), porcines (e.g., pigs), equines (e.g., horses), and avia (e.g., chickens, turkeys). In certain specific embodiments, the source of the manure is dairy cows.

As would be expected, depending on the animal source of the manure, the pH of the AD-produced fiber will have varying pH levels. While the final pH of the pH-adjusted fiber is not absolutely critical, it will be adjusted with elemental sulfur to bring it into a range that is suitable for the plant that is desired to be grown. That is, where the pH-adjusted fiber is intended for growth of acid-loving plants, such as azaleas or rhododendrons, the pH of the fiber will be adjusted to below 7.0, preferably at or below about 6.0. Likewise, where the pH-adjusted fiber is intended for use with plants that prefer moderately basic pH levels, the amount of elemental sulfur added will be less than that added for the fiber intended for acid-loving plants. In general, the pH is adjusted to between about 4.5 and about 8.0, such as about 5.0, about 5.5, about 6.0, about 6.5, about 7.0, or about 7.5. In many embodiments, it is adjusted to a pH of between about 6.5 and 7.5. In other embodiments, the pH is adjusted to any of the possible ranges within these particular values. Of course, any particular specific value for a pH within the above ranges is contemplated (e.g., 6.1, 6.2, 6.3, 6.4, etc.). Those of skill in the art can immediately comprehend each value without all of them being specifically recited herein. It is known that the pH of a composition supporting growth of living organisms can change over time as the substances in the composition are degraded or otherwise acted upon by the organisms (e.g., microorganisms, fungi). Likewise, the make-up of the composition can be changed at a later date by addition of other substances, such as water, fertilizers, or nutrients. Thus, while the pH-adjusted fiber may have a particular pH immediately after production, the invention contemplates changes of pH over time, including changes that might take the pH outside of the ranges contemplated for the original pH.

According to the invention, the substrate is a pH-adjusted fiber produced from AD technology. The pH is adjusted with elemental sulfur, which reduces the pH to a pre-defined desired pH. The amount of elemental sulfur to be added depends on the initial pH of the fiber and the final desired pH. As a general rule, the amount of elemental sulfur added is a sufficient amount to lower the pH to a range that is suitable for growth of a plant of interest, while releasing a suitable amount of various nutrients, including, but not limited to, manganese or iron. As a general rule, amounts in the range of 3 pounds of elemental sulfur per cubic yard of fiber having a pH of 8.0 to 6.5 is typically sufficient to provide a lowered pH and release of a suitable amount of nutrients, such as manganese. Of course, greater or lesser amounts can be added depending on the initial pH of the fiber.

The invention is based, at least in part, on the surprising discovery that elemental sulfur can be used quickly, easily, and economically to reduce the pH of AD-produced fiber, and that this pH reduction results in a composition that is suitable for use as a substrate for growth of plants, including, but not limited to, container plants. Adjustment of the pH of the fiber releases, or generates a compositions capable of readily releasing, nutrients (e.g., iron, manganese) that otherwise would have been bound to the fiber and unavailable for release to support plant growth.

Treating the fiber with elemental sulfur can be by any suitable technique. For example, solid (powderous) elemental sulfur can be added to AD-produced fiber using one or more of the following devices and techniques, following standard practices for using them: paddle mixers, batch mixers, recirculating batch, inline mixers, multistage mixers, and ribbon blenders. The elemental sulfur may be added as a liquid solution; however, the weights involved in doing so on a large scale can make such an embodiment impractical, as can the increase in volume and the newly-imparted liquid characteristics.

The pH-adjusted fiber can be used as, or as part of, a substrate for growth of plants. The substrate can comprise the pH-adjusted fiber. In embodiments, the pH-adjusted fiber can make up at least one-half or the majority of the volume of the substrate, such as 50% or about or more than 50%, 51% or about or more than 51%, 55% or about or more than 55%, 60% or about or more than 60%, 65% or about or more than 65%, 70% or about or more than 70%, 75% or about or more than 75%, 80% or about or more than 80%, 85% or about or more than 85%, 90% or about or more than 90%, 95% or about or more than 95%, 97% or about or more than 97%, 98% or about or more than 98%, 99% or about or more than 99%, or more than about 99.5%.

Although preferred embodiments of the invention provide the pH-adjusted fiber as the main component of a soilless media, in embodiments, it comprises a minority of the volume. For example, in certain embodiments, the pH-adjusted substrate is added as a partial replacement for another soilless substrate, such as peat moss, composed pine bark, or composted hardwood bark. It also may be included in a soilless medium as a minority component, with the rest of the volume being occupied by substances other than peat moss or composted bark, such as inert bulking substances or fillers. In preferred embodiments, the pH-adjusted fiber comprises at least 20% of the final volume of the substrate. Accordingly, in embodiments, the pH-adjusted fiber comprises a minority of the volume of the substrate, such as 49% or about 49% or less, 45% or about 45% or less, 40% or about 40% or less, 35% or about 35% or less, 30% or about 30% or less, 25% or about 25% or less, 20% or about 20% or less, 15% or about 15% or less, or 10% or about 10% or less. Typically, these embodiments relate to nursery or production bed growth of plants, where the plants are grown in-ground or in containers. It is recognized that the pH-adjusted fiber of the present invention is a suitable and economic amendment to peat moss and substrates comprising peat and other components typically used in container and in-ground growth of plants. Thus, the pH-adjusted fiber of the invention can be used as a substitute for pine bark (among other things), which has been known as useful for addition to peat moss to improve water drainage and aeration. In embodiments where the pH-adjusted fiber is used as an amendment to a substrate, it can be added to achieve any final amount, including as little as 0.5% to as much as 50%. For the purposes of the invention, when the pH-adjusted fiber is present in an amount of more than 50%, by volume, it is considered to be the major component of the substrate, and not an amendment. Typically, when the pH-adjusted fiber is added as an amendment, it is added to improve aeration of the roots, to provide improved water and nutrient retention properties, and to increase cation exchange capacity. However, an additional advantage is that use of the pH-adjusted fiber as an amendment can reduce the cost of plant growth media, as compared to other amendments that might provide similar properties.

Soilless substrates for container growth of plants must provide the same functions that substrates containing soil (including soil itself) provide. Current soilless substrates (e.g., peat moss) do not provide the necessary physical and chemical properties as natural soil unless additional substances are added. Therefore, to achieve the necessary physical and chemical properties, to provide the typical functions of soil, and to provide a suitable substrate for growth of plants, soilless substrates are typically amended with various substances, either at the time of production, time of planting, or at various times during growth of the plant.

Common amendments that are added to soilless substrates for growth of plants in containers, include, but are not limited to sand, which reduces drainage in container substrates; clay, which enhances the cation exchange capacity and the water holding capacity of the substrate; pumice, which improves water retention, drainage, and aeration, and reduces bulk density; perlite, which improves water retention and aeration, and reduces bulk density; vermiculite, which improves water retention, improves the cation exchange capacity of the substrate, and reduces bulk density; lime, which raises the pH and supplies calcium and magnesium; gypsum, which supplies calcium and sulfur; humus and other composts, which add nutrients and microbes; and general purpose or custom fertilizers, which add nutrients. Examples of nutrients include, but are not limited to, elements, such as nitrogen, carbon, phosphorous, potassium, sulfur, calcium, magnesium, copper, iron, manganese, zinc, boron, molybdenum, aluminum, and nickel. Additional exemplary amendments include, but are not limited to, surfactants, polymer gels for increased water retention, and inert materials like plastic or styrofoam balls for lightweight bulking. When additional substances are included, a single additional substance may be included, or combinations of two or more additional substances may be included.

Typically, the substances that are included in the substrate are those typically added to container substrates to aid in the growth and maintenance of a plant in a container. The only limitation on the substance that may be included in the substrate is that is must be biologically compatible with the plant to be grown in the substrate, either in the form as added to the substrate or in the form in which it will exist when the substrate is used to grow and/or maintain a plant. Thus, the substrate may be a substance that is toxic to a plant, but that is removed or converted to a non-toxic substance prior to contacting the plant with the substrate. Examples include toxic gases that can be used to sterilize the substrate, solvents that can be used to deliver absorbed or adsorbed substances, and compounds that are degraded by exposure to light, such as UV light. In addition, the substance may be one that is toxic to one or more living organisms other than plants. Thus, it can be a biocontrol agent that is included to inhibit the growth of one or more molds or fungi, or another organism that is detrimental to plant growth or health, that degrades the pH-adjusted fiber, or that creates a toxic product from the fiber or one or more of the amendments present in the substrate. While the pH-adjusted fiber will routinely be free of harmful bacteria and fungi, it is envisioned that certain users will, for any number of reasons, wish to include biocontrol agents as a secondary measure of protection. Numerous biocontrol agents are known in the art, and it is envisioned that any of them can be included in or on the pH-adjusted fiber, or in the substrate in general.

When included, additional substances typically comprise a relatively small portion of the total volume of the substrate, typically less than about 30% of the total volume, more typically less than about 25%, 20%, 15%, 10%, or 5%, such as 3%, 2%, 1% or 0.5% or less of the total volume of the substrate. When included, the substance(s) may be added to the substrate at any time, such as at or about the time of adjusting the pH with elemental sulfur, or after the sulfur has been added. The substance(s) likewise can be added at the time of planting of the plant, and/or at one or more times during the growth and/or maintenance of the plant in the container.

In embodiments, the pH-adjusted fiber can be processed by absorbing or adsorbing onto the surface of the fiber particles (before or after adjusting with elemental sulfur), one or more substances. Adsorbing and absorbing can be accomplished by exposing the fiber to the substance in an appropriate form (e.g., solid, liquid, gas) for a sufficient amount of time to achieve the desired level of adsorption or absorption. Non-limiting examples of substances that can be adsorbed onto or absorbed into the fibers include surface active agents or wetting agents, nutrients, fertilizers, colorants (such as dyes), and water. In embodiments, two or more substances are adsorbed onto or absorbed into the fiber. The amount of each substance to be exposed to the fibers and the amount of time can be selected by those of skill in the art without undue or excessive experimentation.

In certain embodiments, the fiber is colored with a colorant, such as a dye, to produce a substrate having an altered appearance. Substrates having any number of colors can be produced in accordance with this invention, and such colored substrates can have aesthetic appeal to end-user purchasers. For example, a substrate having a tan color, a red color, a yellow color, or a black or very dark brown color may be produced, each having a different appeal to various end-users for use, for example, as a potting substrate or top dressing for container plants grown in the user's home.

Although not included in the calculation in determining the amount of substances present in the substrate, the present invention contemplates water as part of the substrate. Water can be adsorbed onto or absorbed into the fibers or in one or more other substance that may be included in the substrate, such as vermiculite, pumice, perlite, and clay. In such a situation, the volume contributed by the water, if any, is considered to be part of the volume of the pH-adjusted fibers. The water may be pure water or a water solution that contains dissolved or dispersed substances, such as, but not limited to, fertilizers, salts, or nutrients.

In preferred embodiments, the substrate does not comprise a detectable amount of dirt or soil. In yet other embodiments, the substrate does not comprise an amount of dirt or soil that is sufficient to support plant growth on its own. Thus, in embodiments, trace amounts of dirt or soil may be present as minor components, but these amounts will be insignificant, and incapable of supporting growth of a plant without the presence of the pH-adjusted fiber or one or more of the other components in the substrate.

The substrate can be provided in units of any form, including, but not limited to, piles for large-scale use, such as those containing hundreds of pounds or kilograms, or one or more tons or tonnes. For ease of use and transport for smaller purposes, the substrate can be provided in units of bags, such as a bag containing 5 pounds (2.3 kg), 10 pounds (4.5 kg), 20 pounds (9 kg), 30 pounds (13.6 kg), 40 pounds (18 kg), or the like. Alternatively, the contents of the bags can be measured in volumes, and can include 2 cubic feet, 4 cubic feet, 6 cubic feet, or more, or any particular amounts in between these exemplary values. Furthermore, the substrate may be provided in boxes for shipping or storage. Of course, the substrate may be provided in a planting container or pot, in any size, shape, and number (e.g., when a flat of seedlings is provided as a single unit comprising multiple individual containers).

The pH-adjusted fiber can be provided in any of a number of densities. Although the fiber will typically be provided from the AD in a predictable range of densities, one may, if desired, adjust the density to provide a substrate with varying characteristics. For example, when destined for shipping in large volumes, the substrate (whether it be simply pH-adjusted fibers or a substrate comprising additional substances) may be compacted to increase its density and reduce its volume, permitting movement of a greater amount per unit volume. Once at the site of use, the density of the substrate may be adjusted to provide a suitable density for use. Where the substrate was not originally treated to increase density, the density of the substrate may still be adjusted at the site of use to provide the desired density. When provided within a container, the substrate may be packed to any density as well. In embodiments where the substrate is provided in a container for use to grow one or more plants, the substrate is provided in the container at a density that is suitable for growth of the plant. Suitable densities are known in the art. Exemplary densities can be found in a publication by the Ministry of Agriculture, Fisheries and Food of British Columbia, at http://www.agf.gov.bc.ca/omamentals/floriculture/aeration.pdf. Non-limiting exemplary parameters for the substrate in a planting container are: bulk density of about 0.10-0.20 g/cc; total porosity of the substrate of about 70-80%; air space of about 10-25%; container capacity of about 50-65%; available water content of about 25-35%; and unavailable water content of about 20-30%. The particular parameters for any individual embodiment can be selected from among the ranges of parameters given herein or based on parameters known by those of skill in the art to be suitable for growth of plants in containers or in-ground.

The pH-adjusted fiber, and thus substrates comprising it, can be provided in a highly consistent quality, as a result of close control of the anaerobic digestion process producing the fiber in conjunction with careful application of regulated amounts of elemental sulfur to the fiber. That is, unlike small-scale manure composting facilities, industrial AD technology is a scientifically engineered and controlled process that produces a consistent product with known physical and chemical properties. Because of the control that can be exerted during the AD process, and because the solid fiber resulting from the process has known physical and chemical properties, the fiber can be further treated according to the present invention to provide a relatively uniform, consistent product for use in the container plant industry, either in a greenhouse or nursery setting or in a residential/office setting by a consumer user.

In a second aspect, the present invention provides methods of making the substrate of the invention. In general, the methods of making the substrate comprise contacting AD-produced fiber and elemental sulfur to adjust the pH of the fiber. In certain embodiments, the method further comprises providing the fiber, providing the elemental sulfur, or both. The method results in a pH-adjusted fiber that is suitable for use as, or as part of, a substrate for growth of plants, such as those in containers.

The method comprises contacting the fiber and elemental sulfur to adjust the pH of the fiber. The step of contacting can be any step that results in physical contact of at least one molecule of elemental sulfur with at least one individual fiber of the AD-produced fiber. In preferred embodiments, a significant amount, for example at least 20%, of the elemental sulfur available contacts the fiber. In certain embodiments, 25% or at least 25%, 30% or at least 30%, 40% or at least 40%, 50% or at least 50%, 60% or at least 60%, 70% or at least 70%, 75% or at least 75%, 80% or at least 80%, 90% or at least 90%, 95% or at least 95%, or 98% or at least 98% of the elemental sulfur available contacts fibers of the AD-produced fiber.

The amount of sulfur that is contacted with the AD-produced fiber is pre-selected to adjust the pH of the fiber to a pre-selected value. For example, if a final pH-adjusted substrate is desired to have a pH of 6.5, a sufficient amount of elemental sulfur is contacted to the fiber to produce a final pH-adjusted substrate having a pH of precisely or about 6.5. As a general rule of thumb, about 1.5 to 3 pounds of elemental sulfur added to a cubic yard of fiber having a pH of between about 8.5 and about 7.5 is sufficient to achieve an immediate reduction in pH to a value in the range of about 8.0 to about 6.0. Where a more precise pH range or value is desired, additional elemental sulfur may be added. Alternatively, where the adjusted pH is lower than desired, a pH-raising substance, such as lime, may be added to fine-tune the pH. An additional reduction in pH can be achieved over a period of time by addition of water or other substances. Furthermore, growth of one or more plants in the pH adjusted medium can cause further reduction in pH.

In embodiments, elemental sulfur is added to the AD-produced fiber at a rate of about or precisely one and one-half to three pounds of elemental sulfur per cubic yard of fiber. In other embodiments, elemental sulfur is added to the fiber at a rate of about or precisely one and one-half pounds per cubic yard of fiber, about or precisely one and three-quarters pounds per cubic yard of fiber, about or precisely two pounds per cubic yard of fiber, about or precisely two and one-quarter pounds per cubic yard of fiber, about or precisely two and one-half pound per cubic yard of fiber; or about or precisely two and three-quarters pound of sulfur per cubic yard of fiber. In yet other embodiments, elemental sulfur is added to the fiber at a rate of about or precisely three and one-quarter pound of sulfur per cubic yard of fiber. In yet additional embodiments, elemental sulfur is added at about or precisely three and one-half pounds per cubic yard of fiber. Any particular value of sulfur within the range of about 1.5 pounds to about 3.5 pounds of sulfur per cubic yard of fiber may be added to achieve desired results. Thus, in embodiments, elemental sulfur is added at a rate of at least about 1.5 pounds per cubic yard of fiber. In other embodiments, at most about 3.5 pounds of sulfur is added per cubic yard of fiber, such as at most about 3.0 pounds of sulfur, at most about 2.5 pounds of sulfur, at most about 2.0 pounds of sulfur, or at most about 1.5 pounds of sulfur. Of course, in embodiments, elemental sulfur is added at a rate of at least about 1.5 pounds per cubic yard of fiber, at least about 2.0 pounds, at least about 2.5 pounds, or at least about 3.0 pounds. Any suitable range defined by any of these exemplary values, or any whole or fractional number encompassed by them, can also be used to achieve a suitable result.

In embodiments, the method comprises providing AD-produced fiber. The step of providing fiber can be any action that results in fiber being present in a form and amount that is suitable for treatment with elemental sulfur. It thus may comprise obtaining manure or a composition comprising manure from a source (e.g., a farm), and anaerobically digesting the manure or composition. Providing may further comprise separating from the AD, partially, essentially completely, or completely, liquid effluent from solid fiber, and retaining some or all of the fiber. Fiber produced from AD technology may be used immediately (within a day) or maintained at one or more sites for a period of time (e.g., two days, three days, a weeks, 10 days, two weeks, three weeks, a month, etc.) prior to treating with sulfur. It has not been found that maintaining the fiber for an extended period of time causes any degradation in the quality of the fiber or its usefulness in producing a substrate according to the invention.

The amount of fiber provided can be any amount that is suitable for contacting with elemental sulfur. Thus, it may be as small as one or a few grams, or as much as one or more ton. Those practicing the invention may choose the appropriate amount of fiber to use in consideration of any number of parameters, including the amount of fiber and/or elemental sulfur available, the size of the facility available to combine the fiber and the sulfur, the size and number of mechanical devices available for contacting, and preferably mixing, the fiber and sulfur.

The fiber may be any fiber that results from anaerobic degradation of manure. Thus, it may be fiber originating from human or animal waste or manure. As discussed above, it is preferably fiber originating from bovine manure, such as manure from a dairy farm.

In embodiments, the method comprises providing elemental sulfur. The step of providing elemental sulfur can be any action that results in elemental sulfur being present in a form and amount that is suitable for contact with the AD-produced fiber. It can comprise obtaining elemental sulfur from any source, including but not limited to, a commercial vendor. It also may comprise obtaining sulfur in any form from any source and converting it to elemental sulfur through one or more chemical, biochemical, or biological reactions. Thus, it can comprise separating elemental sulfur from one or more substances, including other forms of sulfur or other elements or molecules. The elemental sulfur is preferably provided as a pure or essentially pure substance. However, it can be provided as a component of a composition, preferably as a major component of the composition. When provided as part of a composition, it is highly preferred that the other component(s) in the composition do not negatively affect the ability of the elemental sulfur to adjust the pH of the AD-produced fiber, or negatively affect the ability of the resulting pH-adjusted substrate to function effectively as a substrate supporting growth or maintenance of one or more plants.

The amount of elemental sulfur provided can be any amount that is suitable for contacting with the AD-produced fiber. Thus, it may be as small as one or a few grams, or as much as one or more ton. Those practicing the invention may choose the appropriate amount of sulfur to use in consideration of any number of parameters, including the amount of fiber and/or elemental sulfur available, the size of the facility available to combine the fiber and the sulfur, the size and number of mechanical devices available for contacting, and preferably mixing, the fiber and sulfur.

In preferred embodiments, the step of contacting comprises mixing the elemental sulfur and the fiber, preferably to achieve a homogeneous mixture having a uniform sulfur content and pH throughout the mixture. Mixing can be achieved by any suitable technique, including but not limited to stirring, folding, tossing, or any other mechanical disruption technique. Devices for small-scale, medium-scale, and large-scale mechanical disruption of compositions comprising substances having the physical properties of the fiber of the invention are known in the art, and any such device can be used. For example, mixing can be accomplished using any one or more of the following devices according to standard practices for use of the devices: paddle mixers, batch mixers, recirculating batch, inline mixers, multistage mixers, and ribbon blenders.

Optionally, the method comprises measuring the pH and, if necessary, adjusting it to a desired value. That is, the method comprises contacting the fiber with a pre-determined amount of elemental sulfur, where the amount is calculated to achieve a final pH value. However, it should be understood that it might be necessary in certain occasions to fine-tune the pH to a desired value. Thus, the amount of elemental sulfur, in embodiments, provides a pH-adjusted fiber substrate that has a pH within a pre-selected range. Fine adjustment within this range to achieve a particular pH value is within the process of the invention. Fine adjustment may be by adding additional elemental sulfur, or by adding a different substance that has an effect on pH, such as an acid or lime.

Contacting the elemental sulfur with the fiber results in an adjustment of the pH of the fiber. While adjusting can be either a decrease or an increase, it generally causes a decrease in the pH. That is, fiber produced from AD of farm waste typically has a high pH, which is too high to support adequate plant growth for container growth. Addition of elemental sulfur to the AD-produced fiber reduces the pH to a level that provides adequate growth of plants in the fiber substrate, due at least in part to release of nutrients that were not available to the plants at the higher pH.

The method of the invention can comprise maintaining the elemental sulfur in contact with the fiber for a sufficient amount of time for the pH of the fiber to achieve a stable level. Maintaining can be accomplished at the site where the sulfur and fiber were contacted, or at a different site. A pH level is considered stable if it does not change more than 0.1 unit over a period of one week or more. The step of maintaining may be performed at any time after the sulfur and fiber are contacted, including before or after addition of one or more additional substances to the substrate (e.g., fertilizer, clay, vermiculite, etc.). In embodiments, the pH-adjusted fiber is maintained for a sufficient amount of time for the pH to become stable, then the pH is adjusted to fine-tune it to a desired value. Afterward, the pH-adjusted fiber can be maintained an additional amount of time to determine a new stable pH value. The process of adjusting pH, stabilizing, and determining pH can be repeated any number of times to achieve a desired pH. During this process, the pH may be adjusted upward to provide a substrate having a higher pH than originally obtained through contacting the sulfur and fiber.

The method of producing a pH-adjusted fiber substrate may comprise one or more additional steps, which are referred to herein as further processing steps. For example, the method of producing a pH-adjusted fiber substrate can further comprise adding one or more substances in addition to the fiber and elemental sulfur. Various substances that are suitable for addition to container media are known in the art, and thus need not be detailed here. Exemplary substances are mentioned above. It is to be noted that some of the substances that may be included in the substrate might alter the pH of the pH-adjusted fiber. In cases where the pH is altered to a point outside an acceptable range, the pH may be adjusted as discussed above, to achieve the desired pH.

Of course, the pH-adjusted compositions that are produced may be used in the form that they are produced, or may be divided into two or more units for use, shipping, or any other purpose (e.g., to reduce the size and facilitate packaging or shipping). Thus, further processing can comprise packaging the pH-adjusted substrate in one or more containers, which can be containers for shipping, containers for growth of one or more plants, or any other type of container that is suitable for containing the pH-adjusted fiber of the invention.

Further processing can also comprise transporting the substrate to a site other than the site at which the sulfur and fiber were contacted. For example, it can be transported in bulk to a holding facility, or where it can simply be maintained, where it can be subjected to further processing. It can be transported in bulk or in smaller quantities, for example transported in an unpackaged form in railway cars or trucks for use by one or more nurseries or greenhouses. In addition, it can be transported in a packaged form in bags or the like, for sale to end-user consumers. Transporting can be by any known means, including, but not limited to, trucking, transporting by train, transporting by boat, moving by means of a conveyor belt, shoveling (either manually or using heavy machinery), or any combination of two or more of these. In many embodiments, the substrate of the invention will be moved in bulk from the site of production directly to the site of use, without any packaging or other manipulations being performed in between other than loading onto a truck, train, etc. In such embodiments, the site of use will typically be a greenhouse, nursery, or other commercial plant growing facility. Adding of additional substances to the pH-adjusted fiber, or any other type of further processing may be performed before or after transportation to such commercial sites, or before or after transportation to an end consumer.

Processing can comprise packing the substrate into suitable packaging materials. For example, packing can comprise placing a volume or weight of the substrate in a bag (e.g., a plastic, heat sealable bag, or burlap bag capable of holding 2, 4, or 6 cubic feet), in a box (e.g., a wood box), or in a crate (e.g., a wood crate), and, optionally, sealing the bag, box, or crate. Packing can also comprise placing a volume or weight of the substrate in a container that is suitable for use in growing and/or maintaining a plant. Packing can include any of the various activities performed in the packing industry, without limitation to activities normally associated with packing of agriculture, potting, or landscaping materials.

In view of the above description, it is evident that the present invention provides for the use of manure, such as bovine manure, in the production of a substrate for growth of plants. It likewise provides for use of AD-produced fiber, such as that produced from dairy manure, in the production of a substrate for growth of plants. It further provides for the use of elemental sulfur in the production of a substrate for growth of plants. The plants may be grown in containers or in-ground in controlled media comprising the substrate of the invention.

In a third aspect, the invention provides methods of growing one or more plant. In general, the method of growing a plant comprises contacting at least one plant with a substrate comprising the pH-adjusted fiber of the invention. As used herein, the term plant includes both full plants as well portions of plants (e.g., cuttings) and plant seeds. Thus, the method of growing one or more plant includes germinating a seed and maintaining an established plant for a given time period.

As with the process of contacting sulfur and fiber, contacting of a plant and the substrate can be any action that causes the plant and the substrate to make physical contact with each other, over any amount of surface of any part of either. Typically, contacting will comprise contacting the roots of a plant with the substrate. In embodiments, contacting comprises contacting at least a portion of the surface of a seed with the substrate. In embodiments, the step of contacting is performed more than once, such as initially then after maintaining the plant (or a portion of it) in contact with the pH-adjusted fiber for a period of time.

In embodiments, the method comprises providing the substrate. The act of providing can be any act that makes the substrate available for contact with the plant. In embodiments, the substrate is provided in a container, and thus excludes from the method growth of one or more plants in a natural environment. In embodiments, the method comprises providing at least one plant. The act of providing can be any act that makes the plant available for contact with the substrate. The plant may be at any stage in growth, including a seed, seedling, sapling, or grown or substantially grown plant. The plant can also be a transplanting, such as cuttings, rootings, and the like. The plant may be one grown in a commercial, office, or home setting; therefore, the method of growing can exclude the natural planting of a plant into a substrate through a natural process of seeding, dispersing of seeds, and planting of the dispersed seeds.

Although the plant is typically contacted with the substrate in a container, contacting can occur in container-like settings within in-ground plots, such as those found in nursery and greenhouse settings. The methods of using the substrate to grow plants typically include maintaining the plant in contact with the substrate for a sufficient amount of time for the plant to grow at least a detectable amount. Accordingly, in embodiments, the invention provides for use of the substrate to grow plants.

In general, providing means any activity that makes the substrate and/or plant available for contacting with the other. Thus, providing can be any of a number of activities, including, but not limited to, making the substrate, obtaining pre-made substrate from a manufacturer or a distributor (e.g., a home center, nursery, or greenhouse), and obtaining AD-produced fiber, adjusting the pH with elemental sulfur, and optionally adding one or more other substances.

In preferred embodiments, the method of growing a plant is a method of growing a plant in a container. As used herein, a container is anything that can be used to contain the substrate of the invention and a plant. Thus, a container can be a pot, bag, box, cup, and the like. Typically, the container will be a pot or other item that is used in the art to grow plants, market plants, and maintain living plants in homes or businesses. The containers may be made of any material that is suitable for holding the substrate and a plant. Examples include, but are not limited to, plastic, clay or clay products, ceramic, wood, concrete, plaster, metal, and glass. Such containers and the material they are made from are well known to those of skill in the art, and need not be detailed here.

In embodiments, the substrate is provided in the container before the plant, whereas in others, the substrate is provided after the plant is contained in the container. The order of placement will be a decision to be made by the practitioner, and will be made after considering various relevant parameters, including the shape and size of the container, the size of the plant and its root system, and the like.

A plant according to the invention may be any organism that is classified, under any classification scheme, as a plant. The term includes, without limitation: monocotyledons or dicotyledons; seed bearing, spore bearing, or runner bearing plants; deciduous or coniferous plants; hardwood or softwood plants; and annuals or perennials. Accordingly, a plant according to the invention can be a fruit, a vegetable, an agricultural crop, an ornamental, a flowering plant, a shrub, a vine, a grass, a bulb, a corm, a bedding plant, or a tree. Non-limiting examples of plants according to the present invention include tomatoes, azalea, holly, juniper, rhododendron, boxwood, nandina, crepe myrtle, maple, oak, dogwood, magnolia, crabapple, begonia, impatien, marigold, petunia, pansy, chrysanthemum, geranium, daylily, ornamental grasses, hosta, poinsettia, orchid, African violet, and roses. In particular embodiments, the plant is a petunia. In other particular embodiments, the plant is a geranium. In yet other particular embodiments, the plant is a salvia. In yet further embodiments, the plant is an impatiens. Yet other embodiments relate particularly to ornamental grasses. Additional embodiments relate particularly to vinca minor.

The method of growing one or more plants is not limited to processes that result in an increase in volume or mass of a plant. Rather, the method of growing includes maintaining at least one plant in contact with the substrate for a sufficient amount of time for the plant to either grow in size or mass, or to simply continue to live. Thus, the method includes a process in which at least one plant is subjected to conditions that enable it to perform sufficient metabolic processes to remain alive, even though there is no increase in plant size or mass. The amount of time envisioned by the invention will likely vary from plant to plant, but is not an infinite amount of time. Rather, it is an amount of time that one of skill in the art would recognize as an appropriate amount for a normal life span of the plant. When the plant is a seed, it is generally an amount of time for the seed to germinate and develop a root system that is capable of maintaining or growing the plant. In general, the amount of time that the plant is maintained in contact with the substrate may be weeks, months, or years.

The methods may further include adding additional substances to the substrate, plant, or both before, during, or after contacting the plant and substrate. For example, the method may include adding one or more nutrients to the substrate to maintain a balanced nutrient profile for growth and/or maintenance of the plant. In embodiments, it includes adding fertilizer, preferably in the form of a liquid solution, to the plant, substrate, or both. In preferred embodiments, it includes adding water to the plant, substrate, or both. It may also include adding more substrate to the container containing the plant and substrate. More specifically, because the substrate is organic in nature, it will decompose over time. Thus, the amount of substrate will diminish over time. To provide a suitable environment for continued growth and life, additional substrate, or an alternative substrate, may be added at one or more times during the growth and/or maintenance period. Repotting the plant is an alternative procedure, which is equivalent in effect, to adding additional substrate. Thus, repotting is included among optional steps that can be performed according to the method of the invention.

The method of growing a plant can be practiced on edible plants or plants producing an edible part. In such a situation, the method of growing or maintaining a plant can comprise growing or maintaining the plant until an edible portion is produced. In such a case, the method of growing a plant is also a method of growing food. In these embodiments, the method can comprise harvesting the food, whether it be the entire plant or a portion of the plant, and whether such harvesting results in death of the plant or simply removal of a portion of the plant. In certain embodiments, the method further comprises providing the edible portion to a human or animal for consumption. In embodiments, the method comprises selling all or a portion of the plant to a consumer, either before or after production of an edible part.

The method of growing can be practiced on flowering plants. In such a case, the method can comprise growing the plant until at least one flower has formed. In embodiments, the method can comprise removing the flower and optionally providing the flower to a human. In embodiments, the method comprises selling all or a portion of the plant to a consumer, either before or after production of the flower.

It is preferred to maintain nutritional levels of the substrate at suitable levels throughout the growing and/or maintenance of the plant. Thus, the method of growing a plant can include monitoring and/or adjusting the levels of the substrate or one or more substances that are present in the substrate. Water, nutrients, the volume of substrate, and any other substance or characteristic of the substrate can be monitored and/or adjusted. Suitable growing and maintenance nutritional levels are known in the art, and any such levels may be used within the methods of this aspect of the invention.

In view of the method of growing plants provided by the invention, it should be evident that the invention provides for the use of the substrate of the invention to grow a plant. The substrate can be used to grow a plant from any stage of development, such as from seed, and can include maintaining a living, viable plant in that state for an amount of time, such as for about the amount of time the plant would survive if grown in an alternative soilless medium, such as one containing peat moss.

### EXAMPLES

The invention will be further explained by the following Examples, which are intended to be purely exemplary of the invention, and should not be considered as limiting the invention in any way.

### Example 1

### Adjustment of pH of Fiber with Elemental Sulfur

The suitability of elemental sulfur to reduce the pH of AD-produced fiber was tested using a series of samples of fiber produced from an anaerobic digester. Briefly, the sample was obtained as follows. The digester is described by the designer, GHD, Inc., as a two-stage modified plug-flow mesophilic digester with vertical gas mixing. In addition, the digester has two parallel channels connected at one end resulting in a U-shaped flow pattern. Thus, influent enters and effluent exits at the same end of the digester at adjacent locations. This configuration is not common but is being used where space or desirability of locating influent and effluent in adjacent locations are more effective for the project.

The anaerobic digester is a poured in-place, reinforced concrete tank covered and sealed with reinforced concrete panels. The digester is partially below grade and is insulated to enable maintenance of mesophilic conditions during cold weather. Various details of design and use can be found at the following websites:

http://www.gensets.com/typical_digester_design.htm;

http://www.gensets.com/basic_system_flow.htm;

http://matcmadison.edu/matc/about/initiatives/ceret/symposiumdocuments/DvorakBiogasMar03.pdf; http://www.andgardigester.com/index.cfm?do=page&pageID=1929.

Independent samples were produced from dairy farm manure originating from farms in the states of Washington, Wisconsin, and Indiana. The manure was processed through anaerobic digestion over about one month's time. Anaerobically digested material was then passed through a screw press to reduce liquid content (data indicates approx. 60-50% moisture) in the “solids” fraction after going through the screw press, and the solids were collected.

The fiber was then used in trials to determine the effect of elemental sulfur on initial pH and the pH of the fiber over time. To do so, multiple samples of AD-produced fiber, taken at different times from a digester continuously producing fiber from dairy cow manure, were obtained. Each sample contained at least one cubic foot of fiber. To certain samples to be used as negative controls, the pH of the fiber was recorded using the following protocol: equal volumes of fiber and deionized water at pH 7.0 were mixed thoroughly for one hour at about 25° C., then the mixture allowed to stand still until most solids had settled. The liquid portion was removed and the pH of the liquid portion was measured and recorded.

Alternatively, to certain fiber samples to be used as test samples, elemental sulfur at various amounts was added, and mixed thoroughly. The pH of each sample was then immediately measured, using the protocol described above. The water-soaked pH-adjusted fiber (i.e., sulfur-treated fiber) was left to stand at about 25° C. until a test plant was planted in it (at various times after initial addition of sulfur to the fiber). In the various tests performed, the test plants were: petunia, geranium, salvia, impatiens, ornamental grasses, and vinca minor.

Petunias were grown in the control fiber and pH-adjusted fiber for various lengths of time, and the pH of the fiber was measured at harvesting of the petunias.

Various trials that were performed according to this procedure are detailed in Table 1, which shows the amount of elemental sulfur added, the day of mixing and initial pH testing, the day of planting of the petunia, and the day of harvest. The initial pH of the fiber and the pH of the fiber at the time of harvesting of the petunia are also shown.

TABLE 1
Effect of Elemental Sulfur on pH of Anaerobically Digested Fiber

| | lbs sulfur | | | | | pH at | pH at |
|---|---|---|---|---|---|---|---|
| Trial | per yd³ | Mixed | Planted | Harvested | # of days | planting | harvest |
| 2.1 | 0.0 | Aug. 11, 2003 | Aug. 14, 2003 | Sep. 11, 2003 | 28 | 8.4 | 7.6 |
| | 1.5 | | | | | 8.3 | 7.6 |
| | 3.0 | | | | | 7.7 | 6.8 |
| | 6.0 | | | | | 8.1 | 4.5 |
| | 12.0 | | | | | 8.3 | 2.7 |
| 2.2 | 0.0 | Aug. 11, 2003 | Oct. 3, 2003 | Nov. 6, 2003 | 34 | 7.4 | 7.7 |
| | 1.5 | | | | | 7.3 | 7.5 |
| | 3.0 | | | | | 7.6 | 6.3 |
| | 6.0 | | | | | 7.2 | 4.1 |
| | 12.0 | | | | | 4.5 | 3.1 |
| 2.3 | 0.0 | Aug. 11, 2003 | Mar. 19, 2004 | Apr. 19, 2004 | 31 | 7.5 | 7.2 |
| | 1.5 | | | | | 7.5 | 6.8 |
| | 3.0 | | | | | 7.6 | 5.7 |
| | 6.0 | | | | | 7.0 | 4.4 |
| | 12.0 | | | | | 4.6 | 2.8 |
| 3.1 | 3.0 | Apr. 22, 2004 | Apr. 23, 2004 | May 25, 2004 | 32 | 7.1 | 6.4 |
| | 4.5 | | | | | 7.2 | 5.6 |
| | 6.0 | | | | | 7.2 | 4.8 |
| | 7.5 | | | | | 7.2 | 4.5 |
| | 9.0 | | | | | 7.2 | 3.3 |
| 3.2 | 4.5 | May 6, 2004 | May 7, 2004 | Jun. 28, 2004 | 52 | 7.4 | 3.8 |
| | 6.0 | | | | | 7.7 | 3.4 |
| | 7.5 | | | | | 7.5 | 3.2 |
| 3.3 | 3.0 | Jun. 10, 2004 | Jun. 10, 2004 | Jul. 9, 2004 | 29 | 7.0 | 6.1 |
| | 4.5 | | | | | 7.3 | 5.2 |
| | 6.0 | | | | | 7.3 | 3.6 |
| | 7.5 | | | | | 7.4 | 3.4 |
| | 9.0 | | | | | 7.2 | 3.1 |
| 3.4 | 4.1 | Aug. 16, 2004 | Aug. 19, 2004 | Oct. 20, 2004 | 62 | 6.8 | 4.8 |
| | 5.5 | | | | | 7.2 | 3.8 |
| | 6.9 | | | | | 7.3 | 3.0 |
| | 8.3 | | | | | 7.3 | 3.0 |
| 4.21 | 0.0 | May 4, 2005 | May 5, 2005 | Jun. 7, 2005 | 33 | 8.1 | 7.5 |
| | 1.5 | | | | | 7.5 | 6.7 |
| | 3.0 | | | | | 8.0 | 6.0 |
| | 4.5 | | | | | 7.3 | 4.1 |
| 4.22 | 0.0 | May 4, 2005 | May 26, 2005 | Jun. 22, 2005 | 27 | 7.9 | 7.4 |
| | 1.5 | | | | | 7.0 | 5.8 |
| | 3.0 | | | | | 6.8 | 5.7 |
| | 4.5 | | | | | 6.3 | 5.6 |
| 4.23 | 0.0 | May 4, 2005 | Jun. 13, 2005 | Jul. 6, 2005 | 23 | 7.6 | 7.1 |
| | 1.5 | | | | | 6.7 | 6.5 |
| | 3.0 | | | | | 6.3 | 6.0 |
| | 4.5 | | | | | 5.8 | 4.8 |
| 4.4 | 1.5 | Jul. 28, 2005 | Jul. 28, 2005 | Aug. 24, 2005 | 27 | 7.5 | 7.3 |
| | 2.25 | | | | | 7.3 | 7.1 |
| | 3.0 | | | | | 7.1 | 6.6 |
| 4.51 | 2.0 | Aug. 24, 2005 | Aug. 25, 2005 | Oct. 6, 2005 | 42 | 7.1 | 6.2 |
| | 3.0 | | | | | 7.2 | 6.2 |
| | 4.0 | | | | | 7.1 | 4.8 |
| 4.52 | 2.0 | Aug. 25, 2005 | Aug. 25, 2005 | Oct. 25, 2005 | 46 | 6.6 | 5.5 |
| | 3.0 | | | | | 6.4 | 5.0 |
| | 4.0 | | | | | 6.5 | 4.2 |
| 4.53 | 2.0 | Sep. 22, 2005 | Sep. 22, 2005 | Oct. 26, 2005 | 34 | 6.5 | 5.5 |
| | 3.0 | | | | | 6.4 | 5.2 |
| | 4.0 | | | | | 6.1 | 4.6 |

As can be seen from Table 1, addition of elemental sulfur to AD-produced fiber from dairy cow manure typically causes an immediate drop in the pH of the fiber. In addition, the table shows that addition of elemental sulfur to the fiber causes a general pH drop over time. The general drop in pH is seen at all rates of sulfur added. High rates (e.g., 4.5 pounds per cubic yard or higher) can be seen to quickly lower the pH to a suitable range for growth of most plants, but eventually lower the pH to a level that is unacceptable to many plants. However, quick growth of most plants with such substrates is possible.

In addition, this table shows that pH-adjusted fiber is suitable for growth of container plants. It thus can substitute for peat moss and composted bark as a substrate for growth of container plants. In view of this property, it is evident that it is also suitable as an amendment for currently known container substrates.

### Example 2

### Effect of Treatment of Anaerobically Digested Fiber with Elemental Sulfur on Various Chemical Properties of the Fiber

Upon realization that elemental sulfur can be used to lower the pH of anaerobically digested fiber (as seen in Example 1), the chemical effects of such treatment on the fiber was investigated. More specifically, fiber samples were treated with elemental sulfur as described in Example 1. The samples were tested at various time points after initial treatment, and the pH, Ec, and available iron and magnesium were recorded. The results of this series of tests is reported in Table 2.

TABLE 2
Effect of Time on pH, Ec, and Available Fe/Mn of pH-Adjusted Fiber

| Treatment | | | | | | |
|---|---|---|---|---|---|---|
| (lbs sulfur | Sample | | | | | |
| per yard³) | # | Date | pH | Ec | Fe (ppm) | Mn (ppm) |
| 0.0 | 10 | Sep. 16, 2004 | 8.4 | 2.2 | 0.62 | 0.09 |
| | 11 | Oct. 14, 2004 | 8.4 | 2.0 | 1.80 | 0.28 |
| | 12 | Nov. 11, 2004 | 8.2 | 2.2 | 1.64 | 0.34 |
| | 13 | Dec. 9, 2004 | 8.5 | 2.0 | 0.66 | 0.21 |
| | 14 | Dec. 30, 2004 | 7.8 | 2.3 | 0.35 | 0.07 |
| 3.0 | 20 | Sep. 16, 2004 | 7.9 | 3.1 | 0.47 | 0.17 |
| | 21 | Oct. 14, 2004 | 7.6 | 4.2 | 0.52 | 0.29 |
| | 22 | Nov. 11, 2004 | 6.8 | 4.9 | 0.21 | 0.63 |
| | 23 | Dec. 9, 2004 | 5.9 | 5.1 | 0.30 | 1.82 |
| | 24 | Dec. 30, 2004 | 5.7 | 5.4 | 0.22 | 2.23 |
| 4.0 | 30 | Sep. 16, 2004 | 7.8 | 3.2 | 0.42 | 0.15 |
| | 31 | Oct. 14, 2004 | 7.3 | 3.9 | 0.27 | 0.31 |
| | 32 | Nov. 11, 2004 | 5.4 | 7.0 | 0.45 | 3.93 |
| | 33 | Dec. 9, 2004 | 4.6 | 5.7 | 0.46 | 5.96 |
| | 34 | Dec. 30, 2004 | 4.8 | 4.1 | 0.22 | 2.95 |
| 5.0 | 40 | Sep. 16, 2004 | 7.6 | 2.8 | 0.38 | 0.12 |
| | 41 | Oct. 14, 2004 | 3.5 | 7.0 | 1.02 | 9.40 |
| | 42 | Nov. 11, 2004 | 3.5 | 6.6 | 1.04 | 7.74 |
| | 43 | Dec. 9, 2004 | 3.5 | 5.4 | 0.66 | 6.29 |
| | 44 | Dec. 30, 2004 | 3.2 | 4.8 | 0.68 | 4.41 |
| 6.0 | 50 | Sep. 16, 2004 | 7.9 | 2.3 | 0.46 | 0.11 |
| | 51 | Oct. 14, 2004 | 3.4 | 6.7 | 1.04 | 8.94 |
| | 52 | Nov. 11, 2004 | 3.3 | 7.0 | 1.43 | 8.49 |
| | 53 | Dec. 9, 2004 | 3.2 | 6.0 | 1.39 | 6.65 |
| | 54 | Dec. 30, 2004 | 3.5 | 4.3 | 1.05 | 5.29 |

As can be seen from Table 2, addition of elemental sulfur to AD-produced fiber has an effect on not only pH, but on electrical conductance and amount of available iron and magnesium. One interesting finding of this set of experiments is that there is a range of rates of addition of elemental sulfur to the fiber that provides a suitable pH for growth of plants and a beneficial release of nutrients, and in particular manganese. That is, increasing amounts of elemental sulfur drive the pH of the fiber down in a general fashion, and this pH drop is generally affected by time. However, at certain high rates of sulfur addition (e.g., about 5 pounds per square yard), the pH drop becomes excessive over time for many plants, and the pH-adjusted fiber becomes inadequate for growth of these plants. On the other hand, availability of manganese, and to a lesser extent iron, is also dependent generally on the amount of sulfur added, and is affected by time. The highest availability of manganese is achieved at a pH that is unacceptably low for growth of most plants. However, an acceptable amount of release of manganese (and to some extent, iron too) is achieved at a pH that is acceptable to most plants. Accordingly, the pH-adjusted fiber of the present invention provides not only a suitable pH for a substrate for growth of plants, including container plants, but also provides, at that pH, a substrate having a beneficial amount of available manganese and iron. This advantageously permits growth of plants in the substrate without the need to add externally supplied manganese and iron. Where a higher level of manganese and/or iron is desired, a high rate of sulfur may be added to release these nutrients, and the pH can be raised periodically to a value that is preferred or acceptable to the plant being grown in the substrate.

The Ec levels (soluble salts) found and reported in Table 2 are higher than suggested as acceptable by some practitioners in the art. The levels, however, have proved to be satisfactory in the context of the AD fiber. What needs to be realized is that with peat moss as the organic substrate, significant additional fertilizer (soluble salts) must be added because peat has no inherent nutrients. In contrast, the pH-adjusted AD fiber of the present invention has significant amounts of plant nutrients in it already, hence the higher Ec. Regardless, the data (and photos, not presented herein) indicate that the plants grown in the pH-adjusted fiber substrate performed well and did not demonstrate the problems of “burning” (marginal leaf necrosis) due to high Ec.

### Example 3

### Additional Trial of Adjustment of pH of Fiber with Elemental Sulfur

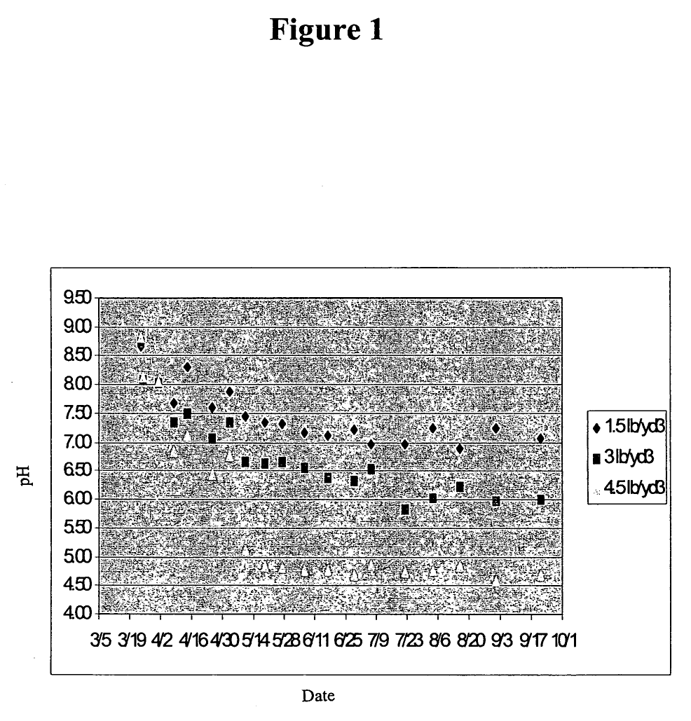

The results of Examples 1 and 2 show that elemental sulfur can be used to achieve a suitable substrate for growth of plants. The testing performed in those Examples was on relatively large samples of fiber. To determine whether the results are repeatable on small samples of fiber, such as those that might be used by end-users (e.g., homeowners) or nurseries potting numerous plants needing different pH conditions (and thus needing only small amounts of fiber at each of a number of pH values), samples of pH-adjusted fiber were made on a small scale. More specifically, a large unit of AD-produced fiber from dairy cow manure was separated into a set of samples, each containing approximately 5-6 grams of fiber. Each sample was treated with an appropriate amount of elemental sulfur to achieve a rate of about 1.5 lbs/yd³, 3.0 lbs/yd³, or 4.5 lbs/yd³ (i.e., about 45 mg, about 90 mg, and about 135 mg of a 90% sulfur composition per about 5.5 grams of fiber). Four samples per rate were used. Treatment was as described above. No plants were planted in the pH-adjusted fiber/substrate. The pH values of the samples were determined periodically over a six month period using the method described above. The results of this series of tests is depicted in FIG. 1, which plot the average of the four samples per rate tested.

FIG. 1 depicts a graph of the pH of the fiber substrate as a function of time. As can be seen from FIG. 1, the speed with which pH drops to an advantageous level for most container plants depends on the rate of sulfur added. In addition, the graph shows that, while high rates (e.g., about or more than about 4.5 pounds of sulfur per cubic yard of fiber) of sulfur can rapidly bring the pH into a suitable range for most plants, at these high rates, the pH rapidly drops to a level that is disadvantageous for growth of many plants. Furthermore, the graph depicted in FIG. 1 shows that there is a range of rates of sulfur addition that can advantageously rapidly lower the pH to a range that is suitable for growth of most container plants, and yet maintain the pH at a suitable level throughout at least a six month period.

The change in pH using a rate of about 1.5 pounds of elemental sulfur per cubic yard of fiber is significant, resulting in a reduction of the pH from about 8.5 to about 7.0 over the six month period monitored. Interestingly, the data show that the pH drops below about 8.0 fairly rapidly, achieving this level within about one month. The pH does not, however, continue to decline of the period tested. Thus, this rate provides an exemplary rate that is suitable for long-term growth of plants in a pH-adjusted fiber/substrate according to the invention.

The change in pH using a rate of about 3 pounds of elemental sulfur per cubic yard of fiber is also significant, resulting in a reduction of the pH from above 8.0 to about 6.0 over the six month period monitored. Consistent with the results obtained using a rate of about 1.5 pounds of sulfur per cubic yard of fiber, the results using about 3 pounds per cubic yard show a rapid drop to about or below pH 7.5 within the first month or so. The pH continues to drop slowly over the next five months, but stays within an acceptable range for growth of most plants. This rate provides another exemplary rate that is suitable for long-term growth of plants in a pH-adjusted fiber/substrate according to the invention.

In contrast to the results obtained at rates of about 1.5 pounds and about 3.0 pounds of sulfur per cubic yard of fiber, use of about 4.5 pounds of sulfur per cubic yard of fiber rapidly drove the pH down to a level at or below 7.0, and continued to drive the pH lower, reaching a level of about 4.5 within little over a month. The rapidly obtained pH level (around or slightly below 7.0) is optimal for many plants. Thus, use of this rate of sulfur rapidly provides a suitable substrate for plant growth. However, within two months, the pH had been driven to a level at or below about 5.0, which is too low for growth and maintenance of many plants. Therefore, while this rate rapidly provides a suitable substrate for plant growth, its long-term suitability is lacking for growth of many plants. Of course, monitoring and adjusting of the pH to maintain it in an acceptable range for the plant of interest can avoid the deleterious effects of the low pH that would be achieved. Furthermore, the low-pH fiber obtained through use of high rates of sulfur can be used as a mix for other pH-adjusted fiber, which might have a pH that is slightly too high, and needs adjusting downward.

Accordingly, FIG. 1 shows that, depending on the rate of sulfur added, a suitable pH for growth of a plant, such as a petunia, can be achieved either very rapidly (with a high rate of sulfur) or more slowly (with a low rate of sulfur). Where a high rate (e.g., 4.5 or greater pounds of sulfur per cubic yard of fiber) is used, the resulting substrate can be used short-term to grow most plants, or it can be used long-term to grow most plants if the pH is monitored and adjusted periodically. Where a moderate rate (e.g., about 1.5 to 3.0 pounds of sulfur per cubic yard of fiber) is used, the resulting pH-adjusted fiber/substrate is suitable for growth of many plants over a long period of time.

The data presented above shows that the pH-adjusted fiber of the invention is suitable for growth of plants. It thus can be used as a replacement or substitute for peat moss. The manure, once it has gone through anaerobic digestion, is very stable. More specifically, what is left after digestion are highly ligninfied organic fibers, which are resistant to further decay, decomposition, and breakdown. This property is very similar to the best peat mosses available, which have undergone essentially the same AD process in bogs over the millennia. This property results in a product that is subject to little or no further break down and less of the resultant loss of porosity that might be seen with other plant growth substrates. One particularly beneficial property of the pH-adjusted fiber of the invention is its air filled porosity. This property provides the pH-adjusted fiber an advantage over other products, such as composted manure.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and Examples be considered as exemplary only, with a true scope and spirit of the invention being indicated by the following claims.

1. A composition comprising anaerobically digested fiber and elemental sulfur, wherein the composition has a pH of 7.5 or lower, and wherein the composition does not comprise soil or dirt.

2. The composition of claim 1, wherein the fiber is produced from dairy cow manure.

3. The composition of claim 1, wherein the composition has a pH of 6.5 or lower.

4. The composition of claim 1, wherein the composition has a pH of 6.0 or lower.

5. The composition of claim 1, wherein the composition has a pH of 7.5 to 6.0.

6. The composition of claim 1, wherein the composition comprises about 1.5 to about 3.0 pounds of elemental sulfur per cubic yard of fiber.

7. The composition of claim 1, further comprising clay, silica, perlite, sand, vermiculite, or a combination of two or more of these.

8. The composition of claim 1, further comprising one or more living plants.

9. A soilless media for growth of plants, said media comprising anaerobically digested fiber and elemental sulfur.

10. The media of claim 9, wherein the media has a pH of 7.5 or lower.

11. The media of claim 9, further comprising clay, silica, perlite, sand, vermiculite, or a combination of two of more of these.

12. The media of claim 9, further comprising at least one living plant.

13. A method of making a soilless substrate for growth and maintenance of at least one plant, said method comprising contacting anaerobically digested fiber and elemental sulfur to adjust the pH of the fiber to a level suitable for growth and/or maintenance of at least one plant.

14. The method of claim 13, further comprising mixing the fiber and sulfur.

15. The method of claim 13, further comprising providing the fiber as a product of anaerobic digestion of farm manure having some, most, or all of its water removed.

16. The method of claim 15, wherein the farm manure comprises dairy cow manure.

17. A method of growing a plant in a soilless media, said method comprising:
providing a soilless media comprising anaerobically digested fiber and elemental sulfur, wherein the media has a pH of 7.5 or below;
contacting at least one plant with the soilless media; and
maintaining the plant and soilless media in contact for a sufficient amount of time for the plant to grow.

18. The method of claim 17, further comprising adding water to the soilless media.

19. The method of claim 18, further comprising selling the plant.

20. The method of claim 18, further comprising placing the soilless media in a container.
